(19) United States
(12) Patent Application Publication
(10) Pub. No.: US 2016/0137916 A1
(43) Pub. Date: May 19, 2016

(54) OPTICAL MATERIAL, OPTICAL FILM, AND LIGHT-EMITTING DEVICE

(71) Applicant: KONICA MINOLTA, INC., Tokyo (JP)

(72) Inventor: Ayako WACHI, Hino-shi, Tokyo (JP)

(21) Appl. No.: 14/900,803

(22) PCT Filed: Jun. 20, 2014
(86) PCT No.: PCT/JP2014/066380

§ 371 Date: Dec. 22, 2015

(30) Foreign Application Priority Data
Jun. 25, 2013 (JP) 2013-132475

(51) Int. Cl. C09K 11/62; C09K 11/02

(52) U.S. Cl. CPC C09K 11/62; C09K 11/02

(57) ABSTRACT

An objective of the present invention is to provide an optical material which has high luminous efficiency and durability that enables suppression of deterioration of semiconductor nanoparticles for a long period of time, said deterioration being caused by oxygen or the like. Another objective of the present invention is to provide: an optical film which has high luminous efficiency and durability; and a light emitting device which is provided with this optical film. An optical material according to the present invention contains semiconductor nanoparticles, and is characterized in that: one or more semiconductor nanoparticles have a surface modifying agent and a surfactant on the surfaces thereof; the semiconductor nanoparticles have at least two coating layers on the outer side of the surface modifying agent and the surfactant; and at least one of the coating layers contains a metal oxide.

### TECHNICAL FIELD

The present invention relates to an optical material, an optical film and a light-emitting device, and in particular, relates to: an optical material and an optical film each having durability capable of preventing semiconductor nanoparticles from degrading, which is caused by oxygen or the like, for a long period of time and having high luminous efficiency; and a light-emitting device provided with the optical film.

### BACKGROUND ART

In recent years, semiconductor nanoparticles have attracted commercial interest because of their size-tunable electronic properties. Semiconductor nanoparticles are expected to be used in a variety of fields such as biological labeling, solar power generation, catalytic actions, biological imaging, light emitting diodes (LEDs), general space lights and electroluminescent displays.

For example, there has been proposed a technique of an optical device utilizing semiconductor nanoparticles, the optical device irradiating the semiconductor nanoparticles with LED light so as to make the semiconductor nanoparticles emit light, thereby increasing the amount of light entering a liquid crystal display (LCD) and increasing luminance of the LCD. (Refer to, for example, Patent Document 1.)

It is known that semiconductor nanoparticles degrade by contacting oxygen. Hence, a variety of means are employed to prevent semiconductor nanoparticles from contacting oxygen. Examples of such means include a method of sealing semiconductor nanoparticles with a barrier film or a sealing material. Although ensures oxygen barrier properties, it requires the sealing work to be carried out under a N₂ atmosphere, for example. Thus, the method requires expensive and high-grade manufacturing equipment and accordingly lacks versatility.

Meanwhile, there has been proposed, as a method for preventing semiconductor nanoparticles from contacting oxygen, a method of coating semiconductor nanoparticles with silica or glass.

For example, the technique described in Patent Document 2 can ensure foaming a silica layer by forming a reverse microemulsion around the semiconductor nanoparticles and subsequently adding a mixture of organic alkoxysilane and alkoxide to respond with the reverse microemulsion. However, this silica layer is in an amorphous state and is insufficient for preventing the semiconductor nanoparticles from contacting oxygen. This technique also has a defect of forming a micelle including a plurality of semiconductor nanoparticles, due to the difficulty of controlling the number of semiconductor nanoparticles taken into the hydrophilic micelle.

Although the technique described in Patent Document 3 and Patent Document 4 can ensure oxygen barrier properties to a certain extent, the method is not sufficient when transparency and durability are considered because it may form silica aggregates of semiconductor nanoparticles and accordingly make the particle size large, thereby decreasing dispersibility thereof in resin and accordingly decreasing transparency; and/or may decrease the oxygen barrier properties due to the external environment and accordingly decrease the luminance, for example.

### RELATED ART DOCUMENTS

### Patent Documents

Patent Document 1: Japanese Patent Application Publication No. 2011-202148

Patent Document 2: Japanese Patent Application Publication No. 2005-281019

Patent Document 3: International Patent Application Publication No. 2007/034877

Patent Document 4: Japanese Patent Application Publication (Translation of PCT Application) No. 2013-505347

### SUMMARY OF THE INVENTION

### Problems to be Solved by the Invention

The present invention has been conceived in view of the above problems and circumstances, and its objects include providing: an optical material having durability capable of preventing semiconductor nanoparticles from degrading, which is caused by oxygen or the like, for a long period of time and having high luminous efficiency; an optical film having durability and high luminous efficiency; and a light-emitting device provided with the optical film.

### Means for Solving the Problems

In order to achieve the above objects of the present invention, causes of the above problems and the like have been examined, and as a result of that, it has been found out that an optical material having coating layers hardly detached by external factors can be obtained by containing therein: semiconductor nanoparticles having a surface modifier and a surfactant on the surface; and two coating layers, wherein at least one of the coating layers includes a metal oxide.

That is, the above objects of the present invention are achieved by the following means.

1. An optical material containing at least one semiconductor nanoparticle, including: a surface modifier and a surfactant on a surface of one or a plurality of the at least one semiconductor nanoparticle; and at least two coating layers outside of the surface modifier and the surfactant, wherein at least one of the coating layers includes a metal oxide.

2. The optical material of item 1, wherein the at least one semiconductor nanoparticle has a core-shell structure.

3. The optical material of items 1 or 2, wherein the metal oxide is at least one type selected from silicon oxide, zirconium oxide, titanium oxide, and aluminum oxide.

4. The optical material of any one of items 1 to 3, wherein one of the coating layers is adjacent to the at least one semiconductor nanoparticle via the surface modifier and the surfactant on the surface of the at least one semiconductor nanoparticle and includes a metal oxide.

5. The optical material of any one of item 1 to 4, wherein one of the coating layers is adjacent to the at least one semiconductor nanoparticle via the surface modifier and the surfactant on the surface of the at least one semiconductor nanoparticle and includes a metal oxide.

6. wherein a thickness of the coating layer including the metal oxide is within a range from 20 to 100 nm.

7. The optical material of any one of items 1 to 6, wherein one of the coating layers other than the coating layer including the metal oxide includes a resin or a modified polysilazane.

8. The optical material of any one of items 1 to 7, wherein the surfactant has a linear alkyl group having 8 to 18 carbon atoms.

9. An optical film provided with a layer including the optical material of any one of items 1 to 8 on a base.

10. A light-emitting device provided with the optical film of item 9.

### Advantageous Effects of the Invention

According to the above techniques described in the present invention, there can be provided: an optical material having durability capable of preventing semiconductor nanoparticles from degrading, which is caused by oxygen or the like, for a long period of time and high luminous efficiency; an optical film having durability and high luminous efficiency; and a light-emitting device provided with the optical film.

Although appearance mechanism of the effects of the present invention and action mechanism thereof are not clear yet, they are conjectured as follows.

The surfactants are selectively taken in between the alkyl chains of fatty acids, examples of surface modifiers, on the surface of the semiconductor nanoparticle. That is, a fat-soluble layer is formed around the semiconductor nanoparticle and the hydrophilic portions of the surfactants cover the surface of the fat-soluble layer. Accordingly, usage of surfactants enables forming a micelle which includes surfactants more densely relative to the amount of semiconductor nanoparticles. Furthermore, the high affinity of the hydrophilic portion on the surface of the micelle and a metal oxide precursor results in improving the binding force between the first coating layer and the micelle. Accordingly, not only the first layer is formed in a uniform thickness but also the uniformity of the thickness of the second layer is improved, and the semiconductor nanoparticle having coating layers which are hardly detached with time and having good durability is considered to be provided.

Using surfactant in addition to the surface modifier which coats the semiconductor nanoparticles enables to form one micelle for one semiconductor nanoparticle stably and to grow a uniform shell on each particle easily. High luminous efficiency is considered to be obtained by controlling the thickness of the metal oxide-containing coating layer and adjusting the distance between the semiconductor nanoparticles so as to avoid concentration quenching.

### BRIEF DESCRIPTION OF THE DRAWINGS

FIG. 1 is an example of an optical material containing a semiconductor nanoparticle according to the present invention.

FIG. 2 is a schematic cross sectional view illustrating an example of a configuration of a light-emitting device.

### EMBODIMENTS FOR CARRYING OUT THE INVENTION

An optical material of the present invention contains at least one semiconductor nanoparticle, including: a surface modifier and a surfactant on the surface of the at least one semiconductor nanoparticles; and at least two coating layers outside of the surface modifier and the surfactant, wherein at least one of the coating layers includes a metal oxide. This feature is a technical feature common to claims 1 to 10.

In terms of improving the advantageous effects of the present invention, the optical material of the present invention preferably has a core-shell structure. Further, the metal oxide is preferably at least one type selected from silicon oxide, zirconium oxide, titanium oxide, and aluminum oxide.

Further, the coating layer adjacent to the semiconductor nanoparticle via the surface modifiers and the surfactants on the surface of the semiconductor nanoparticle preferably includes a metal oxide. This provides a coating layer having higher oxygen barrier performance.

The number of the semiconductor nanoparticles in the region within metal oxide-containing layer is preferably one, in terms of enhancement of luminous efficiency. Furthermore, the thickness of the metal oxide-containing layer is preferably within a range from 10 to 300 nm, more preferably within a range from 20 to 100 nm.

In terms of durability, one of the coating layers other than the metal oxide-containing layer preferably includes a resin or a modified polysilazane. Further, the surfactant preferably has a linear alkyl group having 8 to 18 carbon atoms.

The optical material of the present invention is preferably provided in an optical film and a light-emitting device.

Hereinafter, the present invention, its constituents, and embodiments for carrying out the present invention are detailed. In this application, “-(to)” between values is used to mean that the values before and after the sign are inclusive as the lower limit and the upper limit.

### <<Summary of Optical Material>>

The optical material of the present invention having semiconductor nanoparticles includes a surface modifier and a surfactant on the surface of one or more of the semiconductor nanoparticles; and at least two coating layers outside of the surface modifier and the surfactant, wherein at least one of the coating layers contain a metal oxide.

The optical material of the present invention includes luminescent semiconductor nanoparticles having a quantum dot effect.

According to the present invention, a micelle is formed by coating the surface of the semiconductor nanoparticle with surfactants and a first and a second coating layers are formed around the semiconductor nanoparticle by addition of a metal oxide precursor and decomposition. Accordingly, a semiconductor nanoparticle having an especially improved oxygen barrier property is easily formed. In particular, the alkyl group part of the surfactant is selectively taken in between the alkyl chains functioning as surface modifiers on the surface of the particle by using a linear surfactant. Therefore, it is possible to form a micelle containing surfactants more densely in each particle.

According to this effect, not only the first layer but also the second layer is improved in terms of uniform thickness, and the semiconductor nanoparticle having good stability with time is considered to be provided, by including coating layers which are hardly detached in spite of degradation with time.

A semiconductor nanoparticle is generally said to be easily affected by oxygen, however, the exposed core part is perfectly protected and resistance to degradation factors (such as oxygen and water) is improved, because a metal oxide-containing layer coats a fat-soluble layer consisting of surface modifiers and the alkyl group part of surfactants on the surface of a particle according to the present invention. Further, forming a shell on each particle enables to control the thickness of the metal oxide-containing coating layer and to adjust the distance between the semiconductor nanoparticles so as to avoid concentration quenching. Accordingly, both high luminous efficiency and long term stability are considered to be obtained.

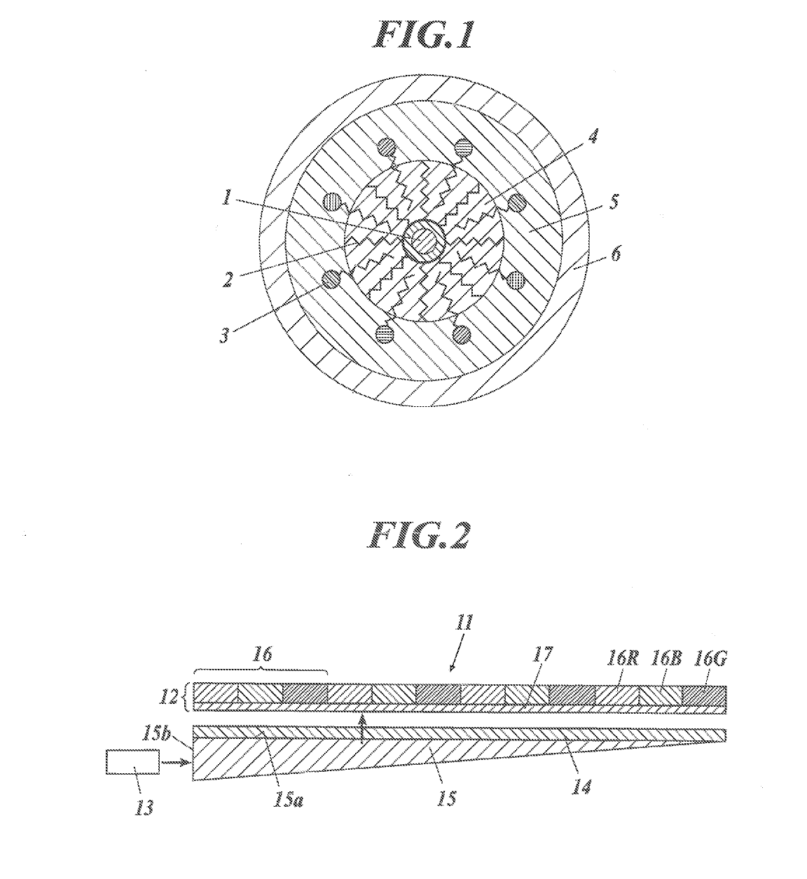

The present invention is explained by referring to figures. FIG. 1 is an example of an optical material containing a semiconductor nanoparticle according to the present invention. Surface modifiers 2 and surfactants 3 exist on the surface of a semiconductor nanoparticle 1 having a core-shell structure. A fat-soluble layer 4 is formed of their alkyl chains. The optical material has a metal oxide-containing layer 5 outside of the surface modifiers 2 and surfactants 3, and has a second coating layer further outside thereof.

Hereinafter, the present invention is further explained in detail.

### <<Semiconductor Nanoparticles>>

The semiconductor nanoparticles according to the present invention are made of crystals of a semiconductor material, are particles of a predetermined size having the quantum confinement effect, are fine particles having a particle size of about several nm to several tens nm, and can have the quantum dot effect described below.

The particle size of the semiconductor nanoparticles according to the present invention is preferably in the range from 1 to 20 nm and far preferably in the range from 1 to 10 nm, to be specific.

The energy level E of such semiconductor nanoparticles is generally represented by the following Expression (1), wherein “h” represents the Planck constant, “m” represents the effective mass of electrons, and “R” represents the radius of the semiconductor particles.

E^{∝}h²/mR² Expression (1)

As shown in Expression (1), a band gap of the semiconductor nanoparticles increases in proportion to “R⁻²”, and the so-called quantum dot effect is obtained. As described above, the particle size of the semiconductor nanoparticles is controlled and defined, whereby the band gap value of the semiconductor nanoparticles can be controlled. That is, the particle size of the fine particles is controlled and defined, whereby diversity which normal atoms do not have can be obtained. Therefore, excitation is carried out with light, and also light can be converted to light of a desired wavelength and emitted. In the present invention, such a luminescent semiconductor nanoparticle material is defined as the semiconductor nanoparticles.

As described above, the semiconductor nanoparticles have an average particle size of about several nm to several tens nm. The average particle size is set to be suitable for a target emission color. For example, the average particle size of the semiconductor nanoparticles is preferably set in the range from 3.0 to 20 nm for red light emission, the average particle size of the semiconductor nanoparticles is preferably set in the range from 1.5 to 10 nm for green light emission, and the average particle size of the semiconductor nanoparticles is preferably set in the range from 1.0 to 3.0 nm for blue light emission.

As a method for measuring the average particle size, a publically-known method can be used. Examples thereof include: a method of observing semiconductor nanoparticles under a transmission electron microscope (TEM) and determining the average particle size as the number average particle size of a particle size distribution; a method of determining the average particle size using an atomic force microscope (AFM); and a method of carrying out the measurement using a particle size measuring apparatus employing dynamic light scattering, for example, a “ZETASIZER Nano Series Nano-ZS” manufactured by Malvern Instruments Ltd. The examples further include a method of deriving, from spectrum obtained by small-angle X-ray scattering, a particle size distribution employing simulation calculation of a particle size distribution of semiconductor nanoparticles. In the present invention, the method of determining the average particle size using an atomic force microscope (AFM) is preferable.

In the semiconductor nanoparticles according to the present invention, the value of an aspect ratio (major axis diameter/minor axis diameter) is preferably in the range from 1.0 to 2.0 and far preferably in the range from 1.1 to 1.7. The aspect ratio (major axis diameter/minor axis diameter) of the semiconductor nanoparticles according to the present invention can be determined by measuring the major axis diameter and the minor axis diameter using an atomic force microscope (AFM), for example. The number of semiconductor nanoparticles to be measured is preferably 300 or more.

### (Material Constituting Semiconductor Nanoparticles)

Examples of the material constituting the semiconductor nanoparticles include: simple substances of group 14 elements of the periodic table such as carbon, silicon, germanium and tin; simple substances of group 15 elements of the periodic table such as phosphorus (black phosphorus); simple substances of group 16 elements of the periodic table such as selenium and tellurium; compounds each consisting of a plurality of group 14 elements of the periodic table such as silicon carbide (SiC); compounds each consisting of a group 14 element of the periodic table and a group 16 element of the periodic table such as tin(IV) oxide (SnO₂), tin(II, IV) sulfide (Sn(II)Sn(IV)S₃), tin(IV) sulfide (SnS₂), tin(II) sulfide (SnS), tin(II) selenide (SnSe), tin(II) telluride (SnTe), lead(II) sulfide (PbS), lead(II) selenide (PbSe) and lead(II) telluride (PbTe); compounds each consisting of a group 13 element of the periodic table and a group 15 element of the periodic table (or group III-V compound semiconductors) such as boron nitride (BN), boron phosphide (BP), boron arsenide (BAs), aluminum nitride (AlN), aluminum phosphide (AlP), aluminum arsenide (AlAs), aluminum antimonide (AlSb), gallium nitride (GaN), gallium phosphide (GaP), gallium arsenide (GaAs), gallium antimonide (GaSb), indium nitride (InN), indium phosphide (InP), indium arsenide (InAs) and indium antimonide (InSb); compounds each consisting of a group 13 element of the periodic table and a group 16 element of the periodic table such as aluminum sulfide (Al₂S₃), aluminum selenide (Al₂Se₃), gallium sulfide (Ga₂S₃), gallium selenide (Ga₂Se₃), gallium telluride (Ga₂Te₃), indium oxide (In₂O₃), indium sulfide (In₂S₃), indium selenide (In₂Se₃) and indium telluride (In₂Te₃); compounds each consisting of a group 13 element of the periodic table and a group 17 element of the periodic table such as thallium(I) chloride (TlCl), thallium(I) bromide (TlBr) and thallium(I) iodide (TlI); compounds each consisting of a group 12 element of the periodic table and a group 16 element of the periodic table (or group II-VI compound semiconductors) such as zinc oxide (ZnO), zinc sulfide (ZnS), zinc selenide (ZnSe), zinc telluride (ZnTe), cadmium oxide (CdO), cadmium sulfide (CdS), cadmium selenide (CdSe), cadmium telluride (CdTe), mercury sulfide (HgS), mercury selenide (HgSe) and mercury telluride (HgTe); compounds each consisting of a group 15 element of the periodic table and a group 16 element of the periodic table such as arsenic(III) sulfide (As₂S₃), arsenic(III) selenide (As₂Se₃), arsenic(III) telluride (As₂Te₃), antimony(III) sulfide (Sb₂S₃), antimony(III) selenide (Sb₂Se₃), antimony(III) telluride (Sb₂Te₃), bismuth(III) sulfide (Bi₂S₃), bismuth(III) selenide (Bi₂Se₃) and bismuth(III) telluride (Bi₂Te₃); compounds each consisting of a group 11 element of the periodic table and a group 16 element of the periodic table such as copper(I) oxide (Cu₂O) and copper(I) selenide (Cu₂Se); compounds each consisting of a group 11 element of the periodic table and a group 17 element of the periodic table such as copper(I) chloride (CuCl), copper(I) bromide (CuBr), copper(I) iodide (CuI), silver chloride (AgCl) and silver bromide (AgBr); compounds each consisting of a group 10 element of the periodic table and a group 16 element of the periodic table such as nickel(II) oxide (NiO); compounds each consisting of a group 9 element of the periodic table and a group 16 element of the periodic table such as cobalt(II) oxide (CoO) and cobalt(II) sulfide (CoS), compounds each consisting of a group 8 element of the periodic table and a group 16 element of the periodic table such as triiron tetraoxide (Fe₃O₄) and iron(II) sulfide (FeS); compounds each consisting of a group 7 element of the periodic table and a group 16 element of the periodic table such as manganese(II) oxide (MnO); compounds each consisting of a group 6 element of the periodic table and a group 16 element of the periodic table such as molybdenum(IV) sulfide (MoS₂) and tungsten(IV) oxide (WO₂); compounds each consisting of a group 5 element of the periodic table and a group 16 element of the periodic table such as vanadium(II) oxide (VO), vanadium(IV) oxide (VO₂) and tantalum(V) oxide (Ta₂O₅); compounds each consisting of a group 4 element of the periodic table and a group 16 element of the periodic table such as titanium oxide (such as TiO₂, Ti₂O₅, Ti₂O₃ and Ti₅O₉); compounds each consisting of a group 2 element of the periodic table and a group 16 element of the periodic table such as magnesium sulfide (MgS) and magnesium selenide (MgSe); chalcogen spinels such as cadmium(II) oxide chromium(III) (CdCr₂O₄), cadmium(II) selenide chromium(III) (CdCr₂Se₄), copper(II) sulfide chromium(III) (CuCr₂S₄) and mercury(II) selenide chromium(III) (HgCr₂Se₄); and barium titanate (BaTiO₃). Preferable are compounds each consisting of a group 14 element of the periodic table and a group 16 element of the periodic table such as SnS₂, SnS, SnSe, SnTe, PbS, PbSe and PbTe; group III-V compound semiconductors such as GaN, GaP, GaAs, GaSb, InN, InP, InAs and InSb; compounds each consisting of a group 13 element of the periodic table and a group 16 element of the periodic table such as Ga₂O₃, Ga₂S₃, Ga₂Se₃, Ga₂Te₃, In₂O₃, In₂S₃, In₂Se₃ and In₂Te₃; group II-VI compound semiconductors such as ZnO, ZnS, ZnSe, ZnTe, CdO, CdS, CdSe, CdTe, HgO, HgS, HgSe and HgTe; compounds each consisting of a group 15 element of the periodic table and a group 16 element of the periodic table such as As₂O₃, As₂S₃, As₂Se₃, As₂Te₃, Sb₂O₃, Sb₂S₃, Sb₂Se₃, Sb₂Te₃, Bi₂O₃, Bi₂S₃, Bi₂Se₃ and Bi₂Te₃; and compounds each consisting of a group 2 element of the periodic table and a group 16 element of the periodic table such as MgS and MgSe. Among these, far preferable are Si, Ge, GaN, GaP, InN, InP, Ga₂O₃, Ga₂S₃, In₂O₃, In₂S₃, ZnO, ZnS, CdO and CdS. These substances do not contain a highly toxic negative element and thus are excellent in resistance to environmental pollution and safety for living organisms, and also can stably have pure spectrum in the visible light range and thus are advantageous in forming light-emitting devices. Among these materials, CdSe, ZnSe and CdS are preferable in terms of stability of light emission. In terms of luminous efficiency, high refractive index, safety and economic efficiency, the semiconductor nanoparticles of ZnO or ZnS are preferable. The above materials may be used individually, or two or more types thereof may be used in combination.

The above-described semiconductor nanoparticles can be doped with a small amount of a variety of elements as impurities as needed. Adding such a dope substance can greatly improve emission properties.

With respect to the emission wavelength (band gap) in the present invention, in the case of the semiconductor nanoparticles of an inorganic matter, the energy difference between the valence band and the conduction band is the band gap (eV) in the semiconductor nanoparticles, and it is represented by emission wavelength (nm)=1240/band gap (eV).

The band gap (eV) of the semiconductor nanoparticles can be measured using Tauc plot.

Tauc plot, which is one of optical scientific measuring methods of the band gap (eV), is described.

The measurement principle of the band gap (E₀) using Tauc plot is described below.

It is considered that the following Expression (A) holds between the optical absorption coefficient α, the light energy hν (wherein h is Planck's constant, and ν is frequency of vibration) and the band gap energy E₀ in the area where absorption is relatively large near the optical absorption edge on the long wavelength side of semiconductor material.

αhν=B(hν−E₀)² Expression (A)

Therefore, the absorption spectrum is measured, hν is plotted against 0.5-square of (αhν) (so-called Tauc plot), and the linear portion is extrapolated, and the value of hν at α=0 is the band gap energy E₀ of semiconductor nanoparticles to obtain.

In the case of semiconductor nanoparticles, the difference between the absorption and emission spectra (Stokes shift) is small and the waveform is sharp, and thus the maximum wavelength of the emission spectrum can be used as a simple indicator of the band gap.

As other methods, cited are: a method of estimating the energy levels of the organic and inorganic functional materials exemplified by methods of determining the band gap from the energy levels obtained by scanning tunneling spectroscopy, ultraviolet photoelectron spectroscopy, X-ray photoelectron spectroscopy and Auger electron spectroscopy, respectively; and a method of optically estimating the band gap.

### (Method for Producing Semiconductor Nanoparticles)

As a method for producing the semiconductor nanoparticles, a publically-known appropriate method conventionally carried out can be used. For example, the semiconductor nanoparticles can be synthesized by referring to publically-known documents, such as Solventless Synthesis and Optical Properties of CdS Nanoparticles: Trans. Mater. Res. Soc. Jpn., 2006, Vol 31, p. 437-440. A publically-known method for synthesizing semiconductor nanoparticles using a micromixer (reactor), described in International Patent Application Publication No. WO2005/023704 etc. The semiconductor nanoparticles can also be purchased as a commercial article from Aldrich Cooperation, Crystalplex Corporation, NN-LABS, LLC. or the like.

Examples of the liquid phase production method include: a reverse micelle method by which a raw material aqueous solution is made present as a reverse micelle in a non-polar organic solvent for crystal growth in the reverse micelle phase, the non-polar organic solvent being exemplified by alkanes such as n-heptane, n-octane and isooctane, and aromatic hydrocarbons such as benzene, toluene and xylene; a hot soap method by which a pyrolytic raw material is poured in a high-temperature liquid phase organic medium for crystal growth; and a solution reaction method which involves crystal growth at a relatively low temperature using an acid-base reaction as driving force as with the hot soap method. Any method among these production methods can be used. In particular, the liquid phase production method using a surface modifier detailed below can be used.

### <<Core-Shell Structure>>

It is preferable that the surface of the semiconductor nanoparticles be coated with a coating film composed of a coating layer of an inorganic matter. More specifically, it is preferable that the surface of the semiconductor nanoparticles have a core-shell structure having a core region composed of a semiconductor nanoparticle material and a shell region composed of a coating layer of an inorganic matter.

This core-shell structure is preferably formed of at least two types of compound, or a gradient structure (inclined structure) may be formed of two or more types of compound. This can efficiently prevent the semiconductor nanoparticles in the application liquid from aggregating and improve dispersibility of the semiconductor nanoparticles, and also improve luminance efficiency and prevent a color shift, which is caused when a light-emitting device using the optical film of the present invention is continuously driven, from occurring. In addition, due to the presence of the coating layer, stable emission properties can be obtained.

The thickness of the shell part is not particularly limited, but preferably in the range from 0.1 to 10 nm and far preferably in the range from 0.1 to 5 nm.

Generally, emission color can be controlled through the average particle size of semiconductor nanoparticles, and when the thickness of the coating film is a value in the above range, the thickness of the coating film is from a thickness corresponding to several atoms to a thickness of less than one semiconductor nanoparticle, filling with semiconductor nanoparticles in high density can be carried out, and a sufficient amount of luminescence can be obtained. Also, the presence of the coating film can prevent a defect present at the particle surfaces of core particles and non-luminescent electron energy transfer, which is caused by an electronic trap to a dangling bond, thereby preventing decrease in quantum efficiency.

### <<Surface Modifier>>

When semiconductor nanoparticles are prepared in a solution, surface modification by organic compounds is generally conducted for stable and uniform dispersion of the synthesized semiconductor nanoparticles, because they have high surface energy and are easily aggregated. The particle size of the semiconductor nanoparticles can be controlled by the stable dispersion. An organic compound having a function described above is called a surface modifier in the present invention.

A molecule used as a surface modifier preferably has a structure where a group having a coordinating ability is bonded at the end of the aliphatic hydrocarbon. For uniform dispersion of nanoparticles in organic solvent and in terms of affinity with the fat-soluble portion of the surfactant, the molecule needs to have a fat-soluble portion. The surface modifier preferably has an alkyl or alkenyl group having five or more carbon atoms. These groups may be branched. In particular, a linear alkyl group is preferable.

Examples of the group having a coordinating ability include a mercapto group, an amino group, a carboxy group, and a phosphonic acid group.

Examples of the surface modifier of the present invention include: trialkylphosphines such as triethylphosphine, tributylphosphine, trihexylphosphine, trioctylphosphine, and tridecylphosphine; alkylphosphine oxides such as triethylphosphine oxide, tributylphosphine oxide, trihexylphosphine oxide, trioctylphosphine oxide, and tridecylphosphine oxide; alkylamines such as hexylamine, octylamine, decylamine, dodecylamine, hexadecylamine, and octadecylamine; dialkyl sulfoxides; fatty acids such as alkanephosphonic acid, linoleic acid, capric acid, lauric acid, myristic acid, palmitic acid, and stearic acid. Among the surface modifiers having a mercapto group at the end, those described in general formula [I] in Japanese Patent Application Publication No. 2005-272795 and selected in terms of the preferable number of carbon atoms can be used.

Among these surface modifiers, fatty acids are preferable. In particular, linear fatty acids having 5 to 20 carbon atoms are preferable. Linear fatty acids enhance the affinity with the alkyl group of the surfactant described below, and a denser layer can be formed on the semiconductor nanoparticles. The resulting micelles can occlude surfactants more densely.

For example, myristic acid, palmitic acid, and stearic acid are particularly preferred.

### <<Surfactant>>

By using a surfactant with the above-described surface modifier, a dense layer can be formed on the surface modifier around the semiconductor nanoparticles. A surfactant may have a branched alkyl group or an unsaturated bond, however, a linear surfactant having a linear alkyl chain is preferable. By using a linear surfactant having a linear alkyl chain, the surfactant is easily taken in between the alkyl chains selectively, being present as a surface modifier on the surface of the semiconductor nanoparticles. Therefore, it is possible to form a micelle containing surfactants more densely in each semiconductor nanoparticle. According to this effect, not only the first coating layer but also the second coating layer is improved in terms of uniform thickness, and the semiconductor nanoparticle having coating layers which are not detached in the case of deterioration and having stability with time can be provided.

Examples of the surfactant which can be used in the present invention include an anionic surfactant, a cationic surfactant, a nonionic surfactant, and an amphoteric surfactant.

Examples of the anionic surfactant include: sodium octanoate, sodiumdecanoate, sodium laurate, sodium myristate, sodium palmitate, sodium stearate, perfluorononanoic acid, sodium N-lauroyl sarcosinate, sodium cocoyl glutamate, α-sulfo fatty acid methyl ester salt, sodium 1-hexanesulfonate, sodium 1-octanesulfonate, sodium 1-decanesulfonate, sodium 1-dodecanesulfonate, perfluorobutanesulfonic acid, sodium linear alkylbenzenesulfonate, sodium toluenesulfonate, sodium cumenesulphonate, sodium octylbenzenesulfonate, sodium dodecylbenzenesulphonate, sodium naphthylsulfonate, naphthalenedisulfonic acid disodium salt, naphthalenetrisulfonic acid trisodium salt, sodium butylnaphthalenesulfonate, sodium laurylsulfonate, sodium myristylsulfonate, sodium laurethsulfonate, sodium polyoxyethylene alkylphenolsulfonate, ammonium lauryl sulfate, lauryl phosphate, sodium lauryl phosphate, and pottasium lauryl phosphate.

Examples of the cationic surfactant include: tetramethyl ammonium chloride, tetramethylammonium hydroxide, tetrabutyl ammonium chloride, dodecyldimethylbenzyl ammonium chloride, alkyltrimethyl ammonium chloride, octyltrimethyl ammonium chloride, decyltrimethyl ammonium chloride, dodecyltrimethyl ammonium chloride, tetradecyltrimethyl ammonium chloride, cetyltrimethyl ammonium chloride, stearyltrymethyl ammonium chloride, alkyltrimethyl ammonium bromide, hexadecyltrimetyl ammonium bromide, benzyltrimethyl ammonium chloride, benzyltriethyl ammonium chloride, benzalkonium chloride, benzalkonium bromide, benzethonium chloride, dialkyldimethyl ammonium chloride, didecyldimethyl ammonium chloride, and distearyldimethyl ammonium chloride.

Examples of the nonionic surfactant include: glyceryl laurate, glyceryl monostearate, sorbitan fatty acid ester, sucrose fatty acid ester, polyoxyethylene alkyl ether, pentaethylene glycol monododecyl ether, octaethylene glycol monododecyl ether, polyoxyethylene alkyl phenyl ether, polyoxyethylene polyoxypropylene glycol, polyoxyethylene sorbitan fatty acid ester, polyoxyethylene hexytane fatty acid ester, sorbitan fatty acid ester-polyethylene glycol, lauric acid diethanolamide, oleic acid diethanolamide, stearic acid diethanolamide, octyl glucoside, decyl glucoside, lauryl glucoside, cetanol, stearyl alcohol, and oleyl alcohol.

Examples of the amphoteric surfactant include: lauryldimethylaminoacetic acid betaine, stearyldimethylaminoacetic acid betaine, dodecylaminomethyldimethylsulfopropyl betaine, octadecylaminomethyldimethylsulfopropyl betaine, cocamidopropyl betaine, cocamidopropylhydroxysultaine, 2-alkyl-N-carboxymethyl-N-hydroxyethyl imidazolinium betaine, sodium lauroyl glutamate, potassium lauroyl glutamate, Lauroylmethyl-β-alanine, lauryldimethylaminen-N-oxide, and oleoyldimethylamine N-oxide.

Among these, the cationic surfactant is particularly preferable. The cationic surfactant can improve the adhesion with the layer including an oxide.

Further, for effective uptake to the alkyl chain of the surface modifier and forming a dense micelle with the surface modifier, the surfactant preferably has a linear alkyl group having 8 to 18 carbon atoms and does not have a branched structure.

Examples of the preferable surfactant include hexadecyltrimetyl ammonium bromide, hexadecyltrimetyl ammonium chloride, dodecyltrimethyl ammonium bromide (DTAB).

Although the amount of the surfactant is not particularly limited, about 2 to 10 times of the semiconductor nanoparticles by mass is preferable.

### <<Metal Oxide-Containing Layer>>

The optical material according to the present invention includes two or more coating layers, at least one of which contains a metal oxide. The coating layer adjacent to the semiconductor nanoparticle via the surface modifier and the surfactant on the surface of the semiconductor nanoparticle preferably contains a metal oxide. This provides a coating layer having higher oxygen barrier performance. It is conjectured that the cause is the uniformly coated surfactant, metal oxide, and outermost coating layer even in a severe atmosphere.

In forming the coating layer including the metal oxide according to the present invention, a thermosetting reaction using sol-gel method is preferably applied for forming an inorganic oxide.

A sol-gel method is a method of forming an inorganic oxide from an organic metal oxide which is a precursor of the inorganic oxide. Specifically, a solution of a metal alkoxide, which is a kind of an organic metal compound and is used as a starting substance, is undergone hydrolysis reaction and polycondensation reaction to form a sol. The sol is further gelled by reacting with the moisture in the air and the like, to obtain a solid inorganic oxide. For example, when tetraethoxysilane (Si(OC₂H₅)₄), which is a metal alkoxide of silicon, is used in the process of forming a silica glass film, a sol of liquid polysiloxane is formed according to the reaction formulas shown below by dissolving tetraethoxysilane in a solvent such as alcohol and by mixing with a catalyst such as an acid and a little water sufficiently.

Si(OC₂H₅)₄+4H₂O→Si(OH)₄+4C₂H₅OH Hydrolysis Reaction

nSi(OH)₄→[SiO₂]n+2nH₂O Dehydration condensation reaction

When a sol of polysiloxane is coated on the coating layer and dried, the volume of the sol contracts in accordance with the evaporation of the solvent and ethyl alcohol (C₂H₅OH) and water produced by the reactions. As a result, the residual OH-groups at the end of the adjacent polymers bind to each other by dehydration condensation reaction and the coating layer becomes a gel (solidified body). Further, a strong metal oxide layer can be obtained by heating the obtained gel coating layer to make the bond between the polysiloxane particles strong.

Examples of metal alkoxides includes metal alkoxides including a single metal, such as Si(OC₂H₅)₄, Al(OC₂H₅)₄, Ti(OCH₃)₄, Ti(OC₂H₅)₄, Ti(iso-OC₃H₇)₄, Ti(OC₄H₉)₄, Zr(OC₂H₅)₄, Zr(iso-OC₃H₇)₄, Zr(OC₄H₉)₄.

The metal oxides of the present invention is preferably at least one type selected from silicon oxide, zirconium oxide, titanium oxide, and aluminum oxide.

Further, for expressing a high luminous efficiency, the number of the semiconductor nanoparticles in the region within the coating layer including metal oxide is preferably one, which can be attained by forming a micelle using nanoparticles including a surfactant having a linear alkyl group treated with a surfactant having a linear alkyl group.

The thickness of the coating layer including metal oxide can be 10 to 300 nm. The thickness of the coating layer is preferably 20 to 100 nm.

### <<Other Coating Layer>>

The coating layer(s) other than the coating layer including the metal oxide preferably includes a resin or a modified polysilazane. Preferably, one layer other than the coating layers including the metal oxide includes a resin or a modified polysilazane. Such layers can further improve durability.

The thickness of the coating layer(s) other than the coating layer including the metal oxide can be 10 to 300 nm.

### <<Resin>>

The other coating layers according to the present invention preferably include resin. The resin is preferably a water-soluble resin in terms of easy manufacturing process.

The water-soluble resin which can be used in the present invention is not particularly limited and can include polyvinyl alcohol based resins, gelatins, celluloses, thickening polysaccharides, and resins having a reactive functional group. Among these, polyvinyl alcohol based resin is preferable. In the present invention, water-soluble compound means a compound which dissolves in water medium in an amount of more than 1% by mass, preferably more than 3% by mass.

The polyvinyl alcohol resins preferably used in the present invention includes not only a normal polyvinyl alcohol (nonmodified polyvinyl alcohol) obtained by hydrolysis of polyvinyl acetate but also a cation-modified polyvinyl alcohol having a cation-modified end, an anion-modified polyvinyl alcohol having an anionic group, a modified polyvinyl alcohol modified with acrylor the like, reactive polyvinyl alcohol (for example, “Gohsefimer Z” available from Nippon Synthetic Chemical Industry Co., Ltd.), vinyl acetate resins (for example, “Exceval” available from KURARAY CO., LTD.). Two or more types of the polyvinyl alcohol resins having different polymerization degrees or different modification types can be used in combination. A silanol modified polyvinyl alcohol having a silanol group (for example, “R-1130” available from KURARAY CO., LTD.) can also be used in combination.

Examples of the cation-modified polyvinyl alcohols include a polyvinyl alcohol having a primary, secondary or tertiary amino group or a quaternary ammonium group in a main chain or a side chain of the above polyvinyl alcohol as described in Japanese Patent Application Publication No. 61-10483. They can be obtained by saponification of a copolymer of ethylenic unsaturated monomer having a cationic group and vinyl acetate.

Examples of the anion-modified polyvinyl alcohols include a polyvinyl alcohol having an anionic group as described in Japanese Patent Application Publication No. 1-206088, a copolymer of a vinyl alcohol and a vinyl compound having a water-soluble group as described in Japanese Patent Application Publication Nos. 61-237681 and 63-307979, and a modified polyvinyl alcohol having a water-soluble group as described in Japanese Patent Application Publication No. 7-285265.

Examples of nonion-modified polyvinyl alcohols include a polyvinyl alcohol derivative having a polyalkylene oxide group described in Japanese Patent Application Publication No. 7-9758 added to a part of the polyvinyl alcohol, and a block copolymer of a vinyl compound having a hydrophobic group as described in Japanese Patent Application Publication No. 8-25795 and a vinyl alcohol. Two or more types polyvinyl alcohols having different polymerization degrees, different modification types, or the like can be used in combination.

Examples of vinyl acetate resins include Exceval (Product name; available from KURARAY CO., LTD.) and Nichigo G-Polymer (Product name; available from Nippon Synthetic Chemical Industry Co., Ltd.).

The polymerization degree of the above polyvinyl alcohols is preferably within the range from 1500 to 7000, more preferably 2000 to 5000.

### <<Modified Polysilazane>>

A modified polysilazane is preferably contained in the coating layer of the present invention. A modified polysilazane is a compound containing at least one type selected from silicon oxide, silicon nitride and silicon oxynitride produced by carrying out modification treatment on polysilazane.

The modified polysilazane is preferably laminated on the metal oxide-containing layer.

The coating layer containing a coating of modified polysilazane can make itself a highly transparent layer having durability capable of preventing the semiconductor nanoparticles from contacting oxygen or the like for a long period of time.

### (1) Material Constituting Polysilazane

The “polysilazane” is a polymer having a silicon-nitrogen bond and is a ceramic precursor inorganic polymer for SiO₂, Si₃N₄, and an intermediate solid solution of these, SiOₓN_{y}, for example, composed of Si—N, Si—H and N—H, for example. A polysilazane or polysilazane derivative is represented by the following General Formula (I)

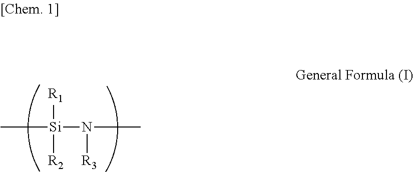

For applying it without impairing the film base, as described in Japanese Patent Application Publication No. 8-112879, one which is modified to silica by becoming ceramic at a relatively low temperature is preferable.

In General Formula (I), R₁, R₂ and R₃ each independently represent a hydrogen atom, an alkyl group, an alkenyl group, a cycloalkyl group, an aryl group, an alkylsilyl group, an alkylamino group or an alkoxy group.

In terms of denseness of the layer to be obtained, perhydropolysilazane, for which R₁, R₂ and R₃ are all hydrogen atoms, is particularly preferable.

Meanwhile, organopolysilazane, for which the hydrogen moiety bonded to Si is partly substituted with an alkyl group or the like, has an advantage of preventing cracks from being generated even when the (average) film thickness is made larger because its adhesion to the base as a base is improved by virtue of having the alkyl group such as a methyl group and toughness is imparted to the hard and fragile ceramic film composed of polysilazane. According to the intended use, either perhydropolysilazane or organopolysilazane may be selected, or they may be used in combination.

It is conjectured that perhydropolysilazane has a structure in which a straight-chain structure and a ring structure mainly having six- and eight-membered rings are present. Perhydropolysilazane has a molecular weight of about 600 to 2000 (polystyrene equivalent) in terms of a number average molecular weight (Mn) and is a liquid or a solid depending on the molecular weight. Perhydropolysilazane is commercially available in the form of a solution by being dissolved in an organic solvent, and the commercial article can be used as it is as a polysilazane-containing solution.

Other examples of polysilazane which becomes ceramic at a low temperature include silicon alkoxide-added polysilazane obtained by reacting silicon alkoxide with polysilazane represented by the above General Formula (I) (Japanese Patent Application Publication No. 5-238827), glycidol-added polysilazane obtained by reacting glycidol therewith (Japanese Patent Application Publication No. 6-122852), alcohol-added polysilazane obtained by reacting alcohol therewith (Japanese Patent Application Publication No. 6-240208), metal carboxylate-added polysilazane obtained by reacting metal carboxylate therewith (Japanese Patent Application Publication No. 6-299118), acetylacetonate complex-added polysilazane obtained by reacting a metal-containing acetylacetonate complex therewith (Japanese Patent Application Publication No. 6-306329), and metal fine particle-added polysilazane obtained by adding metal fine particles therewith (Japanese Patent Application Publication No. 7-196986).

To the coating layer, a catalyst of amine or metal can be added for accelerating conversion of polysilazane into a silicon oxide compound. Specific examples include AQUAMICA NAX120-20, NN110, NN310, NN320, NL110A, NL120A, NL150A, NP110, NP140 and SP140 manufactured by AZ Electronic Materials pcl.

### (2) Modification Treatment

The modification treatment is preferably carried out on polysilazane contained in the semiconductor nanoparticle layer, whereby a part of or all of polysilazane contained in the semiconductor nanoparticle layer becomes modified polysilazane.

The modification treatment may be carried out on the layer coated by the polysilazane, on the applied layer made by applying the optical material coated by the polysilazane, or on both of the layers.

More specifically, for the modification treatment, a publically-known method can be selected based on a conversion reaction of polysilazane. Production of a silicon oxide film or a silicon oxynitride film by a substitution reaction of a silazane compound requires heating at 450° C. or higher, which is difficult to be applied to a flexible substrate of plastic or the like. In terms of applicability to a plastic substrate, use of a method which allows the conversion reaction to proceed at a low temperature, such as plasma treatment, ozone treatment or ultraviolet irradiation, is preferable.

The modification treatment in the present invention is preferably ultraviolet irradiation, vacuum ultraviolet irradiation or plasma irradiation, in particular vacuum ultraviolet irradiation in terms of the modification effect of polysilazane.

Specifically, the ultraviolet irradiation, vacuum ultraviolet irradiation, or plasma irradiation can be conducted in reference to the method for forming gas barrier layers as described in Japanese Patent Application Publication No. 2013-226673.

### (Functional Surface Modifier)

It is preferable that a functional surface modifier adhere to the outermost layer of the optical material of the present invention. This can make dispersion stability of the optical material in the application liquid for forming optical material especially excellent. Also, the functional surface modifier made to adhere to the surface of the optical material makes sphericity of the shaped optical material high at the time of producing the semiconductor nanoparticles and the particle size distribution of the optical material narrow, whereby the semiconductor nanoparticles can be especially excellent.

Examples of the functional surface modifier include: polyoxyethylene alkyl ethers; trialkylphosphines; polyoxyethylene alkylphenyl ethers; tertiary amines; organic phosphorus compounds; polyethylene glycol diesters; organic nitrogen compounds, amino alkanes; dialkyl sulfides; dialkyl sulfoxides; organic sulfur compounds; higher fatty acids; alcohols; sorbitan fatty acid esters; fatty acid modified polyesters; tertiary amine modified polyurethanes; and polyethyleneimines. However, in the case where the semiconductor nanoparticles are prepared by the method described below, as the functional surface modifier, a substance which is coordinated to fine particles of the semiconductor nanoparticles in a high-temperature liquid phase and stabilized is preferable, and to be specific, trialkylphosphines, organic phosphorus compounds, amino alkanes, tertiary amines, organic nitrogen compounds, dialkyl sulfides, dialkyl sulfoxides, organic sulfur compounds, higher fatty acids and alcohols are preferable.

In the present invention, the size (average particle size) of the optical materials is preferably in the range from 50 to 100 nm in terms of distance between the semiconductor nanoparticles and barrier performance. In the present invention, the size of the optical materials represents the total size of the composed of the functional surface modifier at outermost layer. If no functional surface modifier is contained, it represents the size not including them.

As a method for measuring the average particle size of the optical materials, a publically-known method can be used. Examples thereof include a method of observing semiconductor nanoparticles under a transmission electron microscope (TEM) and determining the average particle size as the number average particle size of a particle size distribution. The method for measuring using a transmission electron microscope (TEM) is preferable, because the semiconductor nanoparticles and the coating layer are easily distinguished.

### <<Constitution of Optical Film>>

The optical film according to the present invention has a layer including the optical material of the present invention (hereinafter, also referred to as an optical material layer) on a base. At least one type of the compound selected from a polysilazane or a modified polysilazane described above or the resin described in the explanation of the coating layer is used as a binder.

A gas barrier layer, a protect layer, and the like can be provided as necessary.

### <<Base>>

Examples of the base usable in the optical film of the present invention include but are not particularly limited to glass and plastics and those having translucency are used. Examples of the material preferably used for the base having translucency include glass, quartz and a resin film. Particularly preferable one is a resin film capable of imparting flexibility to the optical film.

The thickness of the base is not particularly limited and can be any.

Examples of the resin film include polyesters, such as polyethylene terephthalate (PET) and polyethylene naphthalate (PEN); polyethylene; polypropylene; cellulose esters and their derivatives, such as cellophane, cellulose diacetate, cellulose triacetate (TAC), cellulose acetate butyrate, cellulose acetate propionate (CAP), cellulose acetate phthalate and cellulose nitrate; polyvinylidene chloride; polyvinyl alcohol; polyethylene vinyl alcohol; syndiotactic polystyrene; polycarbonate; norbornene resin; polymethyl pentene; polyether ketone; polyimide; polyether sulfone (PES); polyphenylene sulfide; polysulfones; polyether imide; polyether ketone imide; polyamide; fluororesin; nylon; polymethyl methacrylate; acrylic; polyarylates; and cycloolefin resin, such as ARTON™ (manufactured by JSR Corporation) and APEL® (manufactured by MITSUI CHEMICALS, INC.).

On the surface of the resin film, a gas barrier film composed of an inorganic matter, an organic matter or both may be formed. It is preferable that this gas barrier film be a gas barrier film having a water vapor permeability (25±0.5° C. and a relative humidity of 90±2% RH) of 0.01 g/(m²·24 h) or less determined by a method in conformity with JIS K 7129-1992. Further, it is preferable that the gas barrier film be a high gas barrier film having an oxygen permeability of 1×10⁻³ ml/(m²·24 h·atm) or less determined by a method in conformity with JIS K 7126-1987 and a water vapor permeability of 1×10⁻⁵ g/(m²·24 h) or less.

As a material which forms the gas barrier film, any material can be used as long as it is impermeable to substances such as moisture and oxygen which degrade the semiconductor nanoparticles. For example, silicon oxide, silicon dioxide, silicon nitride or the like can be used. In order to reduce fragility of the film, it is far preferable that the film have a multilayer structure of an inorganic layer composed of any of the above and a layer composed of an organic material. Although the stacking order of the inorganic layer and the organic layer is not particularly limited, it is preferable that these layers be alternately stacked multiple times.

A method for forming the gas barrier film includes but is not particularly limited to: vacuum deposition, sputtering, reactive sputtering, molecular beam epitaxy, cluster ion beam, ion plating, plasma polymerization, atmospheric pressure plasma polymerization, plasma CVD, laser CVD, thermal CVD and coating.

### <<Other Resin>>

The optical material layer according to the present invention may include ultraviolet curable resin other than the above-mentioned resins.

Examples of the ultraviolet curable resin preferably used include ultraviolet curable urethane acrylate resin, ultraviolet curable polyester acrylate resin, ultraviolet curable epoxy acrylate resin, ultraviolet curable polyol acrylate resin, and ultraviolet curable epoxy resin. In particular, the ultraviolet curable acrylate resin is preferable.

The optical material layer containing the above resin material can be formed by: applying the optical material layer-forming application liquid using a publically-known means, such as a gravure coater, a dip coater, a reverse coater, a wire bar coater, a die coater or an inkjet method; carrying out drying by heating thereon; and carrying out UV curing thereon. The application amount is, in terms of wet thickness, suitably 0.1 to 40 μm, preferably 0.5 to 30 μm, and in terms of dry thickness, 0.1 to 30 μm, preferably 1 to 20 μm, in average.

The resin material contained in the optical material layer is not limited to the ultraviolet curable resin and hence may be thermoplastic resin exemplified by poly(methyl methacrylate) (PMMA) resin or thermosetting resin exemplified by thermosetting urethane resin consisting of acrylic polyol and an isocyanate pre-polymer, phenolic resin, urea-melamine resin, epoxy resin, unsaturated polyester resin, and silicone resin.

### <<Light-Emitting Device>>

The light-emitting device according to the present invention is provided with an optical film including the above-explained semiconductor nanoparticles according to the present invention.

FIG. 2 is a schematic cross sectional view illustrating an example of a configuration of a light-emitting device provided with an optical film including the semiconductor nanoparticles according to the present invention.

As shown in FIG. 2, optical device 11 includes a blue or an ultraviolet light source 13 (also referred to as a primary light source) and an image display panel 12 arranged in an optical path from the light source 13. The image display panel 12 includes, for example, an image display layer 17 such as a liquid crystal layer.

In FIG. 2, some components are omitted, such as a base for supporting the image display layer 17, electrodes and driving circuits for driving the image display layer, and an oriented film for orienting the liquid crystal layer when a liquid crystal image display layer is used.

The image display layer 17 of the optical device 11 shown in FIG. 2 is an image display layer with pixels and each region (“pixel”) in the image display layer 17 can be driven independently from other regions.

The optical device 11 according to the present invention is intended to provide a color image. Accordingly, a color filter unit 16 is provided in the image display panel 12. For providing a full color display by using red, green, and blue (RGB), the image display panel 12 contains, as shown in the figure, a plurality of filter set units 16 consisting of a red color filter 16R, a blue color filter 16B, and a green color filter 16G. Each color filter is disposed by aligning position with each pixel or subpixel in the image display layer 17.

The light source 13 in the optical device 11 can include one or more light emitting diode (LED), which is preferably a blue or an ultraviolet light source.

The optical device 11 has a light guide 15 as an optical system which can provide a substantially uniform irradiation of the light from the light source 13 onto the image display panel 12. The optical system in FIG. 2 includes a light guide 15 having a light-emitting surface 15a which is the substantially coextensive with the image display panel 12. The light from the light source 13 enters the light guide 15 along the light incident surface 15b, is reflected in the light guide 15 in accordance with the principle of total internal reflection, and is finally emitted from the light-emitting surface 15a of the above light guide. Because a light guide having such configuration is publically-known, the detailed explanation of the light guide 15 is omitted here. The optical film 14 according to the present invention is disposed on the light-emitting surface 15a of the light guide 15.

The optical film 14 including the semiconductor nanoparticles according to the present invention preferably includes two or more different materials which emit light having a wavelength ranges different from each other and different from that of the light emitted from the primary light source 13, when irradiated with the light emitted from the primary light source 13. The primary light source 13 preferably emits a light having a wavelength outside the visible spectra range (for example, a light within an ultraviolet (UV) area) or a blue light.

Furthermore, the color filter unit 16 shown in FIG. 2 includes a narrow-band transmission color filter. The full width half maximum (FWHM) of the narrow-band transmission color filter is preferably 100 nm or less, and preferably 80 nm or less in particular.

The example of optical film 14 shown in FIG. 2 includes the optical material of the present invention and is disposed on the light-emitting surface 15a of the light guide 15, however, the optical film 14 may be arranged within the main body of the light guide 15 in optical device 11 according to the present invention. For example, the optical film 14 may be provided by arranging the semiconductor nanoparticles according to the present invention within an suitable transparent matrix, such as a transparent resin formed into a desired shape of the above light guide and then curved.

### EXAMPLES

The present invention will now be described in more detail by way of Examples. The present invention however should not be limited to these Examples. Throughout the Examples, “part(s)” and the symbol indicate “part(s) by mass” and “% by mass” unless otherwise stated.

### Example 1

### Preparation of Optical Material 1

### <<Preparation of Semiconductor Nanoparticles (Particles A) Having a Core-Shell Structure of InP/ZnS>>

Semiconductor nanoparticles (particles A) having a core-shell structure of InP/ZnS was prepared by the method described in Japanese Patent Application Publication No. 2013-505347.

The preparation method is detailed as follows.

Di-n-butyl sebacate ester (100 ml) as a solvent and myristic acid (10.0627 g) as a surface modifier were placed in a three-neck flask was deaerated under a vacuum for 1 hour at 70° C. After that, introduction of nitrogen and heating to 90° C. were carried out. ZnS molecular cluster [ET₃NH₄] [Zn₁₀S₄(SPh)16] (4.7076 g) was added and the mixture was stirred for 45 minutes. After heating to 100° C., In(MA)₃ (1M, 15 ml) and subsequently (TMS)₃P (1M, 15 ml) were added dropwise. The reaction mixture was heated to 140° C. under stirring. At 140° C., In(MA)₃ (1M, 35 ml) (under stirring for 5 minutes) and (TMS)₃P (1M, 35 ml) were further added dropwise. After slow heating to 180° C., In (1M, 55 ml) and subsequently (TMS)₃P (1M, 40 ml) were further added dropwise. By adding precursors as described above, the nanoparticles of InP grew up with increase of maximum emission wavelength from 520 nm to 700 nm at most. This enables to stop reaction at preferred maximum emission wavelength and to keep the temperature for half an hour under stirring. After that, the reaction mixture was cooled to 160° C. and annealed (at a temperature lower than that of the reaction solution by 20 to 40° C.) for 4 days at most. A UV lamp was used at the step so as to assist anneal.

The nanoparticles were separated by adding deaerated and dried methanol (about 200 ml) by cannulation. After the precipitate was settled, the methanol was removed via cannula, with the aid of a filter rod. Deaerated and dried chloroform (about 10 ml) was added in order to wash the solid. The solid was placed under a vacuum for 1 day for drying. InP-core nanoparticles of 5.60 g were produced. The result of element assay showed the maximum PL at 630 nm with FWHM of 70 nm.

<Treatment after Preparation>

A quantum yield of the InP semiconductor nanoparticles prepared as above increased by washing with a dilute hydrofluoric (HF) acid. The semiconductor nanoparticles were dissolved in deaerated and anhyrdous chloroform (270 ml or less). 50 ml of the solution was taken out, placed in a plastic flask, and flushed with nitrogen. Using a plastic syringe, HF (60 mass/mass %, 3 ml) was added to water and further added to deaerated tetrahydrofuran (THF) (17 ml) to produce an HF solution. It took five hours to add the HF solution dropwise to the InP semiconductor nanoparticles. After the addition was completed, the solution was stirred overnight. The excessive HF was removed by drying the etched InP semiconductor nanoparticles extracted through an aqueous solution of calcium chloride. The dried semiconductor nanoparticles were redispersed in chloroform (50 ml) for future use. The maximum PL was 567 nm with FWHM of 60 nm.

### <Growth of ZnS Shell>

20 ml of HF-etched InP-core particles were dried down in a three-neck flask. After adding Di-n-butyl sebacate ester (20 ml) as a solvent and myristic acid (1.3 g) as a surface modifier, deaeration was performed for 30 minutes. The solution was heated to 200° C., followed by addition of anhydrous Zinc acetate of 1.2 g, dropwise addition of (TMS)₂S (1M, 2 ml, at the speed of 7.93 ml/hr). After the addition was completed, the solution was stirred overnight. The temperature of the solution was kept at 200° C. for one hour and then cooled down to room temperature. After separation of the particles by adding deaerated anhydrous methanol (40 ml), centrifugation was carried out. The supernatant was discarded, and deaerated anhydrous hexane (30 ml) was added to the residual solid. After settling for five hours, the solution was centrifuged again. The supernatant was collected and the residual solid was discarded.

The obtained nanoparticles having a core-shell structure of InP/ZnS were dispersed in anhydrous hexane (30 ml).

Through direct observation of the nanoparticles having a core-shell structure of InP/ZnS by a transmission electron microscope, the InP/ZnS semiconductor nanoparticles having a core-shell structure in which the surface of the InP core part was coated with the ZnS shell were observed. Further, through the observation, it was confirmed that the core of the InP/ZnS semiconductor fine particle phosphor prepared by this preparation method had the particle size of 2.1 to 3.8 nm, and the particle size distribution of 6 to 40%. For the observation, a transmission electron microscope JEM-2100 manufactured by JEOL Ltd. was used.

Further, through measurement of an anhydrous hexane solution, optical properties of the InP/ZnS semiconductor fine particle phosphor were measured. It was confirmed that the emission peak wavelength was 430 to 720 nm, and the emission half-value width was 35 to 90 nm. The luminous efficiency reached 80.9% (535 nm) at the highest. For measureing the emission properties of the InP/ZnS semiconductor fine particle phosphor, a fluorescence spectrophotometer FluoroMax-4 manufactured by Jobin Yvon Inc. was used. For the measurement of the absorption spectrum of the InP/ZnS semiconductor fine particle phosphor, a spectrophotometer U-4100 manufactured by Hitachi High-Technologies Corporation was used.

### <<Formation of Micelle>>

150 mmol of octylphenoxy polyethoxyethanol was added to 100 ml of pure water as a surfactant and stirred for two hours at room temperature. 2 ml of the previously prepared hexane solution of the particles A was then added and stirred for three hours at room temperature. After further stirring at 50° C. for 10 minutes on a hotplate, micelles occluding semiconductor nanoparticles are formed.

### <<Formation of Metal Oxide>>

2 ml of zinc alkoxide was added to the aqueous solution including micelles under stirring. The aqueous solution soon became clouded due to the hydrolysis reaction of the zinc alkoxide. The obtained aqueous solution was centrifuged at 5000 rpm for 1 hour, the supernatant was discarded, and the precipitate was redispersed in 50 ml of pure water. Through observation of the obtained particles by a transmission electron microscope, it was confirmed that a plurality of particles were synthesized, each having a diameter of about 300 to 500 nm and containing 10 to 20 particles A.

A peak corresponding to ZnO was detected by crystal structure analysis of the obtained precipitate using an X-ray diffraction apparatus (Shimadzu Corp., XRD-7000). The formation of particles including a plurality of particles A in ZnO was confirmed by the analysis.

### <<Formation of Second Coating Layer>>

A second coating layer (a metal oxide-coating layer) was formed as follows.

2 ml of TEOS (tetraethyl orthosilicate) was added to the aqueous solution including particles A coated by ZnO under stirring. After stirring at room temperature for two hours, the obtained solution was centrifuged at 5000 rpm for 1 hour, the supernatant was discarded, and the precipitate was redispersed in 50 ml of ethanol to prepare optical material 1. By using a transmission electron microscope and an X-ray diffraction apparatus as described above, the formation of a coating layer of SiO₂ (silica) was confirmed. According to the measured result of the diameter of the particles, the thickness of the silica shell was estimated to be 30 to 80 nm.

### <<Preparation of Optical Material 2>>

In the preparation of optical material 1, the kind of the surfactant was changed from octylphenoxy polyethoxyethanol to tetrabutylammonium chloride of the same mass. Optical material 2 was prepared in the same way as the optical material 1 except that the first coating layer was changed from ZnO to SiO₂ using TEOS and the second coating layer was changed from SiO₂ to Al₂O₃ using aluminium alkoxide. The condition for preparing the coating layers are as follows.

### (Condition for Preparing Coating Layers)

2 ml of TEOS was added to the aqueous solution including micelles under stirring. The obtained aqueous solution was centrifuged at 5000 rpm for 1 hour, the supernatant was discarded, and the precipitate was redispersed in 50 ml of pure water. By further adding 5 ml aluminium alkoxide to the obtained aqueous solution and stirring for 2 hours at room temperature, a second coating layer is formed. Through observation of the obtained particles by a transmission electron microscope, it was confirmed that a plurality of particles were synthesized, each containing 5 to 10 particles A and having a diameter of about 300 to 500 nm. According to the difference in the diameter of the particles before and after the formation of the second coating layer, the thickness of Al₂O₃ was estimated to be 50 to 80 nm.

### <<Preparation of Optical Material 3>>

In the preparation of optical material 1, the kind of the surfactant was changed from octylphenoxy polyethoxyethanol to hexadecyl trimethyl ammonium bromide (DTAB) of the same mass. Optical material 3 was prepared in the same way as the optical material 1 except that the first coating layer was changed from ZnO to a layer of polyvinyl alcohol (PVA) resin. The second coating layer was SiO₂ as in the preparation of optical material 1.

Condition for preparing the first coating layer is as follows.

After addition of a surfactant, 2 ml of 10% PVA aqueous solution was added and stirred at 50° C. for 1 hour to form the first coating layer. After adding 10 ml of ethanol, the obtained aqueous solution was centrifuged at 5000 rpm for 1 hour, the supernatant was discarded, and the precipitate was redispersed in 50 ml of pure water.

10 ml of TEOS was added to the obtained aqueous solution under stirring and further stirred at room temperature for 2 hours. The obtained aqueous solution was centrifuged at 5000 rpm for 1 hour, the supernatant was discarded, and the precipitate was redispersed in 50 ml of pure water.

Through observation of the obtained particles by a transmission electron microscope, it was confirmed that particles were synthesized, each containing one particle A and having a diameter of about 100 to 150 nm. According to the contrast in the TEM image, the thickness of SiO₂ layer, the outermost layer, was estimated to be about 30 nm. Accordingly, the thickness of PVA layer was estimated to be about 70 to 120 nm.

### <<Preparation of Optical Material 4>>

In the preparation of optical material 1, the kind of the surfactant was changed from octylphenoxy polyethoxyethanol to tetrabutylammonium chloride (DTAB) of the same mass. Optical material 4 was prepared in the same way as the optical material 1 except that the first coating layer was changed from ZnO to SiO₂ using TEOS and the second coating layer was changed from SiO₂ to a layer of polyvinyl alcohol (PVA) resin.

### (Condition for Preparing Coating Layers)

After addition of a surfactant, 2 ml of TEOS was added and stirred at 50° C. for 1 hour to form the first coating layer. The obtained aqueous solution was centrifuged at 5000 rpm for 1 hour, the supernatant was discarded, and the precipitate was redispersed in 50 ml of pure water.

2 ml of 10% PVA aqueous solution was added to the obtained aqueous solution under stirring. The obtained aqueous solution was centrifuged at 5000 rpm for 1 hour, the supernatant was discarded, and the precipitate was redispersed in 50 ml of pure water.

Through observation of the obtained particles by a transmission electron microscope, it was confirmed that particles coated with SiO₂/PVA were synthesized, each containing one particle A. According to the contrast in the TEM image, the thickness of SiO₂-coating layer on the surface of the semiconductor nanoparticle was estimated to be about 10 nm and the thickness of the PVA-coating layer was estimated to be about 30 to 80 nm.

### <<Preparation of Optical Materials 5 and 6>>

Optical materials 5 and 6 were prepared in the same way as the optical material 4 except that the SiO₂ in the first coating layer was changed as shown below, the thicknesses of the coating layers were respectively adjusted to be 50 nm by controlling the stirring time after adding titanium alkoxide and zirconium alkoxide. Optical material 5: A layer of TiO₂ was formed using titanium alkoxide. Optical material 6: A layer of ZrO₂ was formed using zirconium alkoxide.

### <<Preparation of Optical Material 7>>

Optical material 7 was prepared in the same way as the optical material 4 except that the thickness of the first coating layer was changed from 10 nm to 50 nm by extending the stirring time after adding TEOS.

### <<Preparation of Optical Material 8>>

Optical material 8 was prepared in the same way as the optical material 7 except that the second coating layer was changed from PVA to SiON(silicon oxynitride) as follows.

The second coating layer: After the first coating layer being formed, the particles were dispersed in methanol and centrifuged again for separation of the precipitate. The obtained precipitate was dispersed in propanol. 0.5 ml of perhydropolysilazane (PHPS: Aquamica NN120-10, the absence of a catalyst type, made by AZ Electronic Materials Co., Ltd.) was added to the propanol solution under stirring, and further stirred at about 40° C. for 1 hour. 1 ml of methanol was added to the solution to promote oxidation.

From the result of crystal structure analysis using XRD, it was confirmed that the particles were coated with SiON film.

### <<Preparation of Optical Material 9>>

Optical material 9 was prepared in the same way as the optical material 8 except that the thickness of the first coating layer was changed from 50 nm to 80 nm by further extending the stirring time after adding TEOS and that the second coating layer was changed to SiON (silicon oxynitride) processed with excimer treatment as follows.

The second coating layer: After forming the first coating layer, the particles were dispersed in methanol and centrifuged again for separation of the precipitate. The obtained precipitate was dispersed in propanol. 0.5 ml of perhydropolysilazane (PHPS: Aquamica NN120-10, the absence of a catalyst type, made by AZ Electronic Materials Co., Ltd.) was added under stirring the propanol solution, and further stirred at about 40° C. for 1 hour. 1 ml of methanol was added to the solution to promote oxidation.

The precipitate was isolated by centrifugation. A glass substrate was coated with the precipitate and modified using excimer light.

### <Excimer Irradiation Device>

Device: Excimer irradiation unit Model MECL-M-1-200 manufactured by M.D.COM., Inc.

Irradiation wavelength: 172 nm

Lamp filled gas: Xe

<Modification Treatment Conditions>

On the film with the semiconductor nanoparticle layer-forming application liquid applied, the film being fixed onto a movable stage, modification treatment was carried out with the following conditions.

Excimer lamp light intensity: 130 mW/cm² (172 nm)

Distance between sample and light source: 1 mm

Stage heating temperature: 70° C.

Oxygen concentration in irradiation unit: 0.01%

Excimer lamp irradiation time: 5 seconds

### <<Preparation of Optical Material 10>>

Optical material 10 was prepared in the same way as the optical material 9 except that core particles composed of InP which were prepared without the step of growing ZnS shell in the preparation of particle A was used instead of the semiconductor nanoparticles (particles A) having a core-shell structure of InP/ZnS.

### <<Preparation of Optical Material 11>>

0.9 ml of methyl methacrylate, 0.15 ml of ethylene glycol dimethacrylate, and 1 mass % PVA solution were added to an anhydrous hexane solution including the semiconductor nanoparticles (particles A) having a core-shell structure of InP/ZnS and stirred for 15 minutes. Subsequently, 10 ml of 1 mass % PVA solution was then added and stirred for 10 minutes. The reaction solution was then heated to 72° C. and stirred for 12 hours.

Through observation of the obtained particles by a transmission electron microscope, it was confirmed that a plurality of particles were synthesized, each containing a large number of particles A and having a diameter of about 1000 to 3000 nm.

### <<Preparation of Optical Material 12>>

1 g of aerosol OT was dissolved in isooctane (2,2,4-trimethylpentane) solution. To the solution were added 0.7 ml of pure water and 0.3 ml of anhydrous hexane solution including the semiconductor nanoparticles (particles A) having a core-shell structure of InP/ZnS under stirring and further stirred for 20 minutes, 0.5 ml of TEOS and 0.7 ml of APS were added to the solution and further stirred for 48 hours at room temperature.

Through observation of the obtained particles by a transmission electron microscope, it was confirmed that a plurality of particles were synthesized, each containing 5 to 10 particles A and having a diameter of about 50 to 100 nm.

### <<Preparation of Optical Material 13>>

Hexadecyl trimethyl ammonium bromide (DTAB) was added to an anhydrous hexane solution including the semiconductor nanoparticles (particles A) having a core-shell structure of InP/ZnS and the solution was stirred at room temperature for 2 hours. After further stirring at 50° C. for 10 minutes, micelles occluding the semiconductor nanoparticles are formed. 2 ml of TEOS (tetraethyl orthosilicate) was added to the obtained aqueous solution including micelles. After stirring at room temperature for 2 hours, the obtained aqueous solution was centrifuged at 5000 rpm for 1 hour, the supernatant was discarded, and the precipitate was redispersed in 50 ml of ethanol. The comparative semiconductor nanoparticles having a single coating layer of SiO₂ were thus prepared. By using a transmission electron microscope and an X-ray diffraction apparatus, the formation of particles coated with SiO₂ including one particle A was confirmed. According to the measured result of the diameter of the particles, the thickness of the silica shell was estimated to be 30 to 80 nm.

The thickness of the coating layer of the obtained particles was measured through observation by a transmission electron microscope.

With respect to each type of the optical material as prepared above, optionally selected 10 optical materials were observed by a transmission electron microscope to count the number of the semiconductor nanoparticles within the coating layer including a metal oxide. The results are shown in Table 1 as numbers of the occluded semiconductor nanoparticles.

### <<Production of Optical Films 1 to 13>>

With respect to each of the optical materials 1 to 13, the diameter of the core in the semiconductor nanoparticles was adjusted to obtain InP/ZnS core-shell nanoparticles for red light emission and green light emission. The optical materials were prepared by forming a coating layer (a first coating layer) including a metal oxide and a second coating layer as described above.

With respect to each of the optical materials, 0.75 mg of the particles for emitting red light and 4.12 mg of the particles for emitting green light were dispersed in 10 ml of anhydrous hexane with 100 μl of organically modified surfactant (BYK-310). 20 ml of PMMA resin solution was added to the dispersion solution, followed by kneading for 30 minutes. A PMMA resin solution was further added to prepare an optical material layer-forming application liquid including the semiconductor nanoparticles in a proportion of 1% by mass.

The semiconductor nanoparticle layer-forming application liquid was applied to a 125 μm thick polyester film (KDL86WA manufactured by Teijin DuPont Films Japan Ltd.) having both sides processed for easy adhesion so as to be a dry thickness of 100 μm, and dried at 60° C. for three minutes. Thus, optical films 1 to 13 were produced.

### <<Evaluations of Optical Films>>

With respect to the thus-produced optical films 1 to 13, the evaluations of luminous efficiency and durability and were made.

### (Evaluation of Luminous Efficiency)

When the optical films 1 to 13 were excited with blue-violet light of 405 nm, the luminous efficiency of emission of white light at a color temperature of 7000 K was measured. For the measurement, an emission measuring system MCPD-7000 (manufactured by Otsuka Electronics Co., Ltd) was used. The luminous efficiency evaluated by taking that of the comparative optical film 11 as 100 is shown in Table 1.

### (Evaluation of Durability)

After accelerated degradation treatment was carried out on the produced optical films 1 to 13 under an environment of 85° C. and 85% RH for 3000 hours, the luminous efficiency was measured as described above. The ratio of the luminous efficiency after the accelerated degradation treatment to the luminous efficiency before the accelerated degradation treatment was obtained and durability was evaluated with the following criteria.

∘: ratio of 0.95 or more

∘Δ: ratio of 0.90 or more and less than 0.95

Δ: ratio of 0.80 or more and less than 0.90

Δx: ratio of 0.50 or more and less than 0.80

x: ratio of less than 0.50

TABLE 1

| | | Semi- | | | First coating layer | | | Second coating layer | | Luminous | | |
|---|---|---|---|---|---|---|---|---|---|---|---|---|
| Optical | Optical | conductor | | | | Thickness | | | Thickness | efficiency | | |
| material | film | nano- | Surface | | Compo- | of coating | | Compo- | of coating | (Relative | Dura- | |
| No. | No. | particle | modifier | Surfactant | sition | layer (nm) | *1 | sition | layer (nm) | value (%)) | bility | Remarks |
| 1 | 1 | InP/ZnS | Myristic | Octylphenoxy | ZnO | 300~500 | >10 | SiO₂ | 30~80 | 120 | Δ | Present |
| | | | acid | polyethoxy- | | | | | | | | invention |
| | | | | ethanol | | | | | | | | |
| 2 | 2 | InP/ZnS | Myristic | Tetrabutyl- | SiO₂ | 200~400 | 5~10 | Al₂O₃ | 50~80 | 120 | Δ | Present |
| | | | acid | ammonium | | | | | | | | invention |
| | | | | chloride | | | | | | | | |
| 3 | 3 | InP/ZnS | Myristic | DTAB | PVA | 70~120 | 1 | SiO₂ | 30 | 130 | ∘Δ | Present |
| | | | acid | | | | | | | | | invention |
| 4 | 4 | InP/ZnS | Myristic | DTAB | SiO₂ | 10 | 1 | PVA | 30~80 | 130 | ∘Δ | Present |
| | | | acid | | | | | | | | | invention |
| 5 | 5 | InP/ZnS | Myristic | DTAB | TiO₂ | 50 | 1 | PVA | 30~80 | 190 | ∘Δ | Present |
| | | | acid | | | | | | | | | invention |
| 6 | 6 | InP/ZnS | Myristic | DTAB | ZrO₂ | 50 | 1 | PVA | 30~80 | 200 | ∘Δ | Present |
| | | | acid | | | | | | | | | invention |
| 7 | 7 | InP/ZnS | Myristic | DTAB | SiO₂ | 50 | 1 | PVA | 30~80 | 190 | ∘Δ | Present |
| | | | acid | | | | | | | | | invention |
| 8 | 8 | InP/ZnS | Myristic | DTAB | SiO₂ | 50 | 1 | Oxidized | 30~80 | 210 | ∘ | Present |
| | | | acid | | | | | PHPS | | | | invention |
| 9 | 9 | InP/ZnS | Myristic | DTAB | SiO₂ | 80 | 1 | Excimer | 30~80 | 230 | ∘ | Present |
| | | | acid | | | | | light-treated | | | | invention |
| | | | | | | | | PHPS | | | | |
| 10 | 10 | InP | Myristic | DTAB | SiO₂ | 80 | 1 | Excimer | 30~80 | 200 | ∘ | Present |
| | | | acid | | | | | light-treated | | | | invention |
| | | | | | | | | PHPS | | | | |
| 11 | 11 | InP/ZnS | Myristic | — | PVA | 30~80 | >10 | — | — | 100 | x | Comparative |
| | | | acid | | | | | | | | | example |
| 12 | 12 | InP/ZnS | Myristic | — | SiO₂ | 50 | 5~10 | — | — | 110 | x | Comparative |
| | | | acid | | | | | | | | | example |
| 13 | 13 | InP/ZnS | Myristic | — | SiO₂ | 30~80 | 1 | — | — | 170 | x | Comparative |
| | | | acid | | | | | | | | | example |

*1: Number of occluded semiconductor nanoparticles (Number)

As shown in Table 1, the optical films 1 to 10 of the present invention have excellent results in luminous efficiency and durability compared to the comparative films 11 to 13. Among the optical films of the present invention, the optical films 9 to 11 containing perhydropolysilazane as the coating layer are excellent. In particular, the optical film 9 including the semiconductor nanoparticles having core-shell structure processed with excimer treatment is excellent.

### Example 2

### Production of Light-Emitting Device

The optical films 1 to 13 produced in Example 1 were provided with the light-emitting device illustrated in FIG. 2 to produce light-emitting devices 1 to 13.

Specifically, as illustrated in FIG. 2, each optical film 14 was stuck on the light-emitting surface 15a of the light guide 15.

### <<Evaluations of Light-Emitting Device>>

After leaving each of the light-emitting devices produced as above under an environment of 85° C. and 85% RH for 3000 hours, the luminous efficiency was measured. It could be confirmed from the result that the light-emitting devices of the present invention showed less change in luminous efficiency as compared with that at the initial stage of light emission and have excellent durability, compared to the comparative devices.

### INDUSTRIAL APPLICABILITY

The optical material according to the present invention has durability capable of preventing semiconductor nanoparticles from degrading, which is caused by oxygen or the like, for a long period of time and has high luminous efficiency; and is suitable to provide an optical film having durability and high luminous efficiency and a light-emitting device provided with the optical film.

### DESCRIPTION OF REFERENCE NUMERALS

1 semiconductor nanoparticle having a core-shell structure
2 surface modifier
3 surfactant
4 fat-soluble layer
5 metal oxide-containing layer
6 second coating layer
11 light-emitting device
12 image display panel
13 light source (primary light source)
14 optical film
15 light guide
15a light-emitting surface
15b light incident surface
16 color filter unit
16B, 16G, 16R color filter
17 image display layer

1. An optical material containing at least one semiconductor nanoparticle, comprising:
a surface modifier and a surfactant on a surface of one or a plurality of the at least one semiconductor nanoparticle; and
at least two coating layers outside of the surface modifier and the surfactant, wherein at least one of the coating layers includes a metal oxide.

2. The optical material of claim 1, wherein the at least one semiconductor nanoparticle has a core-shell structure.

3. The optical material of claim 1, wherein the metal oxide is at least one type selected from silicon oxide, zirconium oxide, titanium oxide, and aluminum oxide.

4. The optical material of claim 1, wherein one of the coating layers is adjacent to the at least one semiconductor nanoparticle via the surface modifier and the surfactant on the surface of the at least one semiconductor nanoparticle and includes a metal oxide.

5. The optical material of claim 1, wherein the number of the at least one semiconductor nanoparticle in the optical material is one.

6. The optical material of claim 1, wherein a thickness of the coating layer including the metal oxide is within a range from 20 to 100 nm.

7. The optical material of claim 1, wherein one of the coating layers other than the coating layer including the metal oxide includes a resin or a modified polysilazane.

8. The optical material of claim 1, wherein the surfactant has a linear alkyl group having 8 to 18 carbon atoms.

9. An optical film provided with a layer comprising the optical material of claim 1 on a base.

10. A light-emitting device provided with the optical film of claim 9.
